(19) United States
(12) Patent Application Publication
(10) Pub. No.: US 2010/0262339 A1
(43) Pub. Date: Oct. 14, 2010

(54) Automatic time adjusting device for GPS of car safety control system

(76) Inventor: Ching-Shan Chang, Hsin-Chuang City (TW)

Correspondence Address: Muncy, Geissler, Olds & Lowe, PLLC, 4000 Legato Road, Suite 310, FAIRFAX, VA, 22033, US

(21) Appl. No.: 11/976,721

(22) Filed: Oct. 26, 2007

(30) Foreign Application Priority Data
Aug. 9, 2007 (TW) 096129478

(51) Int. Cl. G06F 19/00; G01S 19/42; G01C 21/26

(52) U.S. Cl. 701/45

(57) ABSTRACT

An automatic time adjusting device of a GPS of car safety control systems is disclosed. The car safety control system includes at least a car DVR, a GPS receiver and some other components such as a plurality of image sensors, a speaker and a car display monitor so as to achieve monitoring for vehicular safety. The GPS receiver receives the location information, clock signals of the Greenwich Mean Time (GMT) and standard second signal from a GPS satellite. By means of a time zone setting unit, the value of the time difference between the GMT and each of 24 the time zones on earth is provided according to the GPS location information. Then a microprocessor calculates the value of the time difference and determines the current time data such as the values of year/month/day/hour/minute/second in accordance with the car location. Due to connections between the car DVR, the GPS receiver, the time zone setting unit and the microprocessor, the current time data and/or location information such as the latitude and longitude of vehicles are/is recorded and displayed synchronously in the digital image data of the car DVR or displayed on a display unit of the car DVR. Therefore, performance of the car safety control system is improved.

### BACKGROUND OF THE INVENTION

The present invention relates to an automatic time adjusting device of car security systems, especially an automatic time adjusting device using GPS receivers for taking location information, clock signals of Greenwich Mean Time (GMT) and standard second signal from a GPS satellite so that current time data and/or location data (latitude and longitude) of vehicles are/is synchronously recorded or displayed on digital image data of a car digital video recorder (DVR).

Nowadays, cars are quite popular transportation equipment. Along with requirements of various users, a lot of car accessories are available. The GPS (global positioning system) or mobile security systems are the most popular devices. The GPS includes GPS receivers taking positioning information from a network of satellites. In combination with a preset electronic map and a display, a GPS receiver determines the location, speed and direction of the user. The GPS receiver is operated in the reference location relative to the global WGS-84 coordinate system with the C/A code. Details of structure and function of the GPS are not described here due to its popularity.

Regarding car security systems, a video recorder and player (or storage device) such as a DVR or other related device is generally connected with various monitoring devices such as small image sensors, back-view mirror display systems, mobile displays, speakers, remote controllers and GPS receivers in order to ensure driving safety. With reference to TW Pat. No. 1257353, TW Pat. No. 1273052, US2007/0080826A1, US2007/0153085A1, CN101015018A, CN1988655A, CN101001357, and CN101001358A, a DVR basically includes a plurality of data storage units (storage media) for recording dynamic video and/or audio data. The data detected by the monitoring system is saved in real-time recording into the data storage unit in digital formats. A conventional analog recorder and player are replaced by a digital video recorder and player. Digital recording of data can be easily stored and searched. Moreover, the cost and space of storage units are saved. A DVR is disposed with a hard disk and a video capture card which saves digital video data from image sensors arranged in or on surfaces of cars into the hard disk. This means that real time image is captured by an image sensor and is sent to the DVR to be saved and time-recorded. The hard disc space is selectable according to users' requirements. For example, with regard to a security system at a site or in a building, a hard disc can record images for about 400 to 720 hours if a 30 GB hard disc is used to record images in dynamic formats. With regard to a car security system, a small size hard disk is used as a storage unit for the purpose of saving cost and space as well as easy installation. A lot of image data in the hard disc can be copied to other storage devices (storage media) such as discs for convenience of filing or managing. Due to the development of compression techniques of digital images and high compression ratios, digital recording is suitable for long-term, continuous recording.

With regard to a conventional car security system, although devices in the car already include a DVR and a GPS receiver, the two devices work separately with respective settings and effects. For example, the GPS receiver takes real time location information of vehicles and sends the data to the car DVR for the driver's reference. Yet such information is within the existing functions of the GPS receiver, and there is no extra function in combination with the car DVR. Moreover, when the car DVR records and saves real time image data caught by images sensors, the “time” displayed on the image data is in accordance with preset time values (such as year/month/hour/minute/second) of the car DVR. The time may not be the current time of the vehicle. This is due to the time difference in the different time zones on earth. There are 24 time zones on earth and the “starting” point for calculating all different time zones is the Royal Greenwich Observatory, in Greenwich, England. Going from west to east, you move one hour ahead (later) for each zone and, proceeding from east to west, you move one hour back (earlier) for each zone. Some countries are so large they span more than one time zone. In the USA, for example, you would have to change your watch if you travel far enough from the east coast to the west coast. Thus the time shown on the image data of the car DVR is not the current time of the image caught by the image sensor. There is a time difference between the “time recorded” and the current time of the vehicle. Sometimes this leads to a negative effectin filing, data search management and data comparison. Although users can adjust and set the time again in the car DVR, they need to check the time zone of the location and get the values of the time difference. This causes an inconvenience in the operations of the car safety control system.

### SUMMARY OF THE INVENTION

It is therefore a primary object of the present invention to provide an automatic time adjusting device for the GPS of car safety control systems. The car safety control system includes at least one car DVR (Digital Video Recorder) and a GPS receiver that receives location information, clock signals of Greenwich Mean Time (GMT) such as year/month/day/hour/minute/second/millisecond data, and standard second signal from the GPS satellite. By means of a time zone setting unit, the value of the time difference between the GMT and each of the 24 time zones on earth is provided according to the GPS location information. Then a microprocessor (such as the central processing unit (CPU)) calculates the value of the time difference and determines the current time data such as the values of the year/month/day/hour/minute/second in accordance with the car location. Due to the connections between the car DVR, the GPS receiver, the time zone setting unit and the microprocessor, the current time data and/or location information (latitude and longitude) of vehicles are/is recorded and displayed synchronously by the car DVR so as to improve the effect of the car safety control system.

It is another object of the present invention to provide an automatic time adjusting device for the GPS of the car safety control systems that displays the current time data on a display unit of a car DVR so that the driver knows the current time by the display unit of the car DVR. Thus the efficiency of the car safety control system is enhanced.

### BRIEF DESCRIPTION OF THE DRAWINGS

FIG. 1 is a block diagram of a car DVR in a car safety control system of the present invention;

FIG. 2 is a schematic drawing showing an embodiment of an automatic time adjusting device with a car DVR, a GPS receiver, a time zone setting unit and a microprocessor according to the present invention;

FIG. 3 is a schematic drawing showing how real-time data is displayed by a display of a car DVR according to the present invention;

FIG. 4 is a schematic drawing showing current time data of vehicles is recorded and displayed synchronously on the digital image of the car DVR according to the present invention;

FIG. 5 is a schematic drawing showing the current time data and location information (latitude and longitude) of vehicles are recorded and displayed synchronously on the digital image of the car DVR according to the present invention;

FIG. 6 is a schematic drawing showing the time adjustment between a car DVR, a GPS receiver, a time zone setting unit and a microprocessor of a car safety control system according to the present invention;

FIG. 7 is the perspective view of a display unit of a car DVR of an embodiment according to the present invention;

FIG. 8 is perspective view of a display unit of a car DVR of another embodiment according to the present invention.

### DETAILED DESCRIPTION OF THE PREFERRED EMBODIMENT

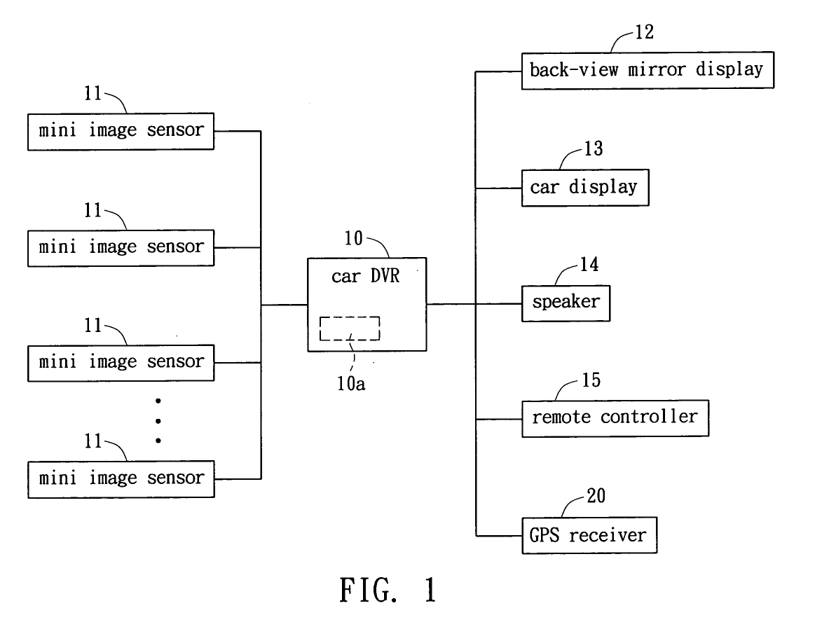

With reference to FIG. 1, a car safety control system of the present invention includes at least a car DVR (Digital Video Recorder) 10 and a GPS (global positioning system) receiver 20. The DVR 10 is connected with various kinds of monitoring devices such as mini image sensors 11, back-view mirror displays 12, car displays 13, speakers 14, remote controllers 15 and GPS receivers 20 in order to ensure driving safety. The mini image sensor 11 is a CMOS (Complementary Metal-Oxide-Semiconductor) or CCD (Charge Coupled Device) sensor that is disposed on the front or rear of the car to catch dynamic real time images and transmit the image data to the car DVR 10 for the data storage and time-recording of the image data in a data storage unit 10a. The back-view mirror display 12 and the car display 13 are used, to show the data received by the mini image sensor 11 as well as the GPS receiver 20 while an alarm or traffic condition is reported from the speaker 14 to provide the driver with the current dynamic conditions. Moreover, the GPS receiver 20 can display the current travel position and the related messages onto a display of the GPS receiver 20, or transmit the data to the DVR10 for the driver's reference. The GPS receiver 20 is operated in the reference location relative to the global WGS-84 coordinate system with the C/A code.

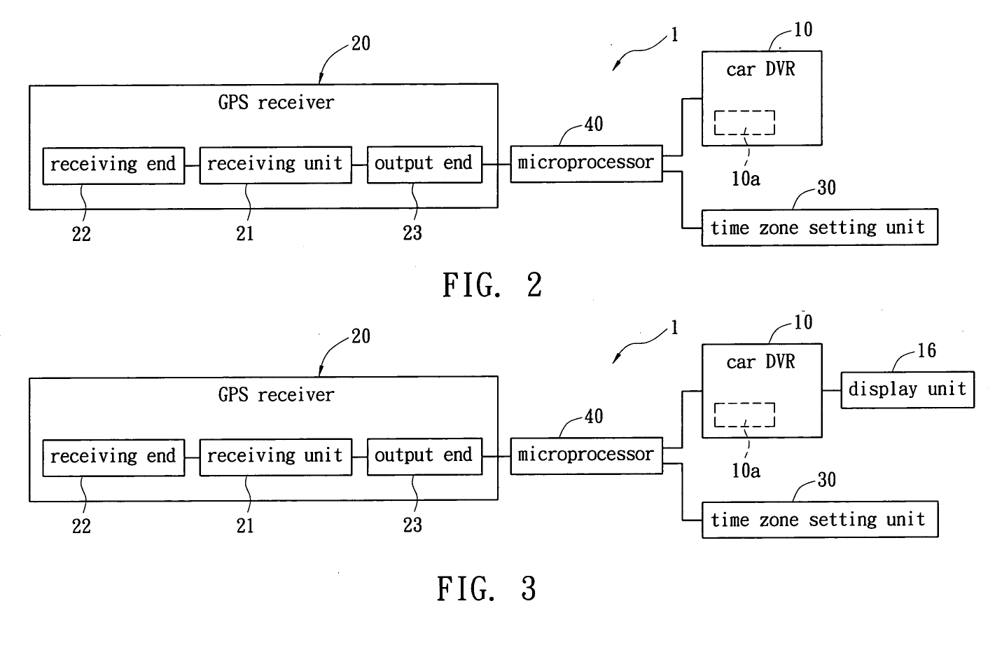

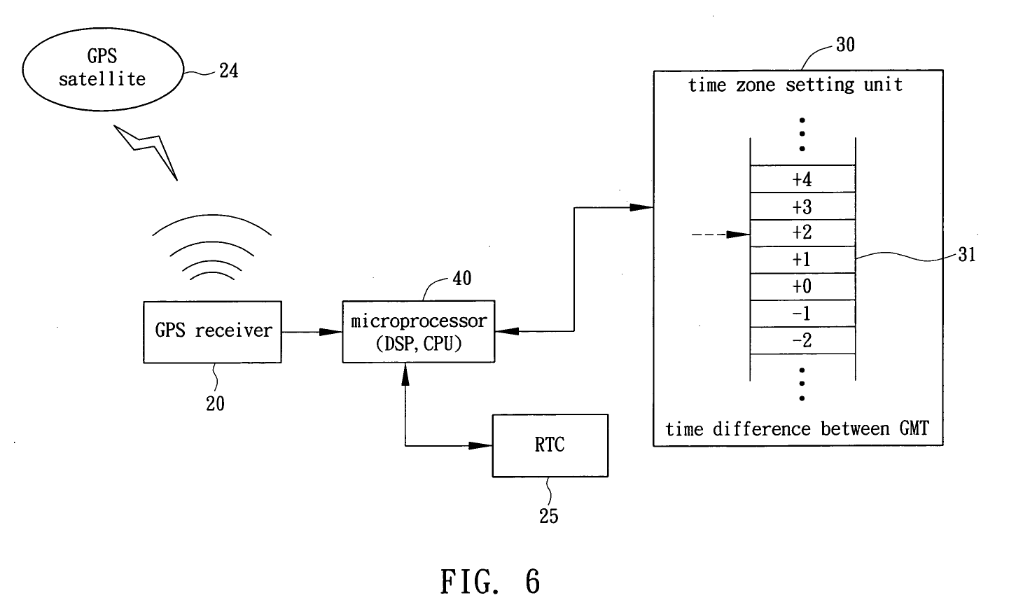

With reference to FIG. 2 & FIG. 6, an automatic time adjusting device for the GPS of the car safety control systems consists of at least a car DVR 10, a GPS receiver 20, a time zone setting unit 30 and a microprocessor 40. The car DVR 10 includes at least one data storage unit 10a for recording dynamic images and/or sounds in the digital manner. In the car safety control system, the data detected by various kinds of monitoring devices such as mini image sensors 11, back-view mirror displays 12, car displays 13, speakers 14, remote controllers 15 and GPS receivers 20 is sent to and is saved in the storage device 10a, as shown in FIG. 1.

With reference to FIG. 2, the GPS receiver 20 is operated in the reference location relative to the global WGS-84 coordinate system with the C/A code and is composed of a receiving unit 21, a receiving end 22 and an output end 23. With reference to FIG. 6, by the receiving unit 21 and the receiving end 22, the GPS receiver 20 takes location information, clock signals of the Greenwich Mean Time (GMT) such as the year/month/day/hour/minute/second/millisecond and the standard second signal from a GPS satellite 24 and sends the information to the microprocessor 40 by the output end 23.

The time zone setting unit 30 is used to set the values of the time difference 31 between the GMT time and each of the 24 time zones on earth by the help of the vehicle positioning information from the GPS, as shown in FIG. 6, and is coupled with the microprocessor 40. The microprocessor 40 (a central processing unit (CPU) or a digital signal processor (DSP)) is connected with the output end 23 of the GPS receiver 20 and the time zone setting unit 30 in order to process the values of the time difference between each time zone and the standard GMT time provided by the time zone setting unit 30 and to determine the current time data having the values of year/month/day/hour/minute/second. Then the data is transmitted to the data storage unit 10a of the car DVR 10. As to the RTC (real time clock) 25 shown in FIG. 6, its aim is to keep the DVR 10 tracking the current time irrespective of whether the signal transmission between the GPS 20 and the microprocessor 40 continues or stops.

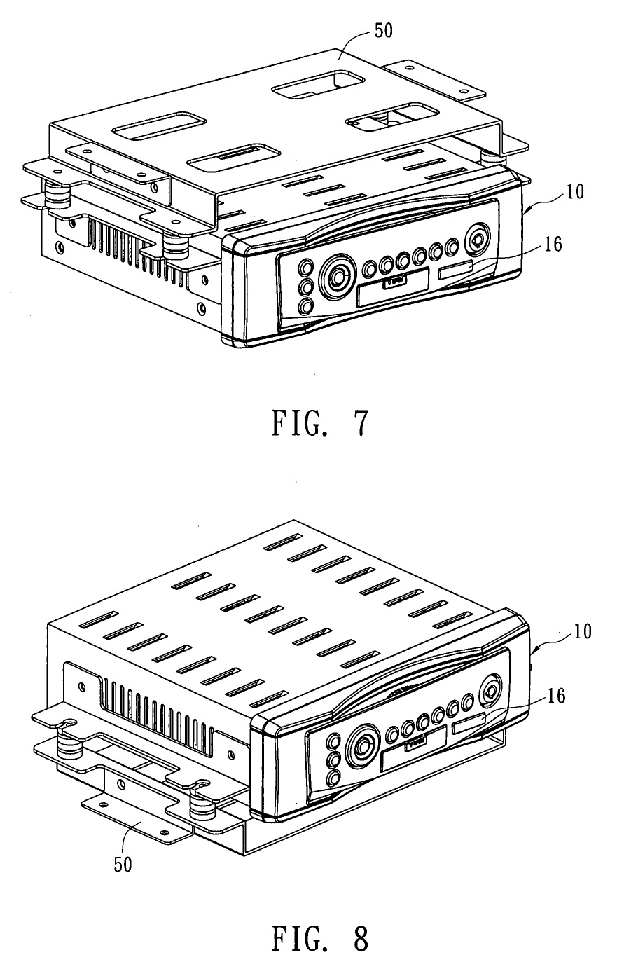

With reference to FIG. 3, FIG. 7 and FIG. 8, the present invention further includes a display unit 16 disposed in the car DVR 10 in order to show the current time data. Thus the driver can know the current time data by the aid of the display unit 16 in the car DVR 10. Therefore the efficiency of the car safety control system is enhanced.

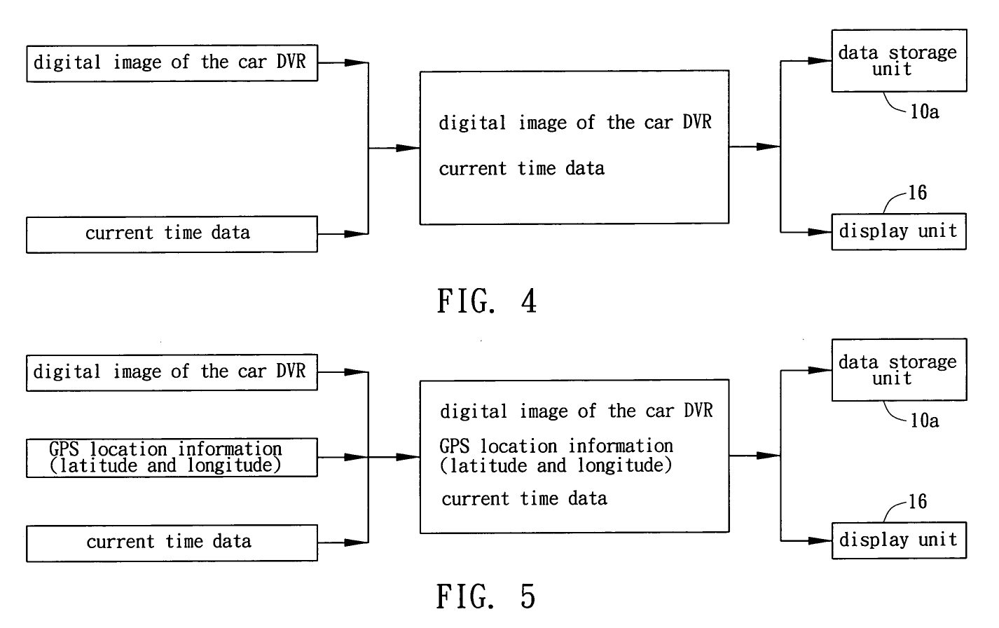

With reference to FIG. 2 & FIG. 3, the connections between the car DVR 10, the GPS receiver 20, the time zone setting unit 30 and the microprocessor 40 enable the current time data (as shown in FIG. 4) and the location information such as the latitude and longitude (as sown in FIG. 5) of vehicles to be recorded and displayed synchronously on the digital image data of the car DVR 10 so that the effectiveness of the car safety control system is enhanced.

With reference to FIG. 7 & FIG. 8, the present invention further includes a support 50 of the car DVR 10 so that the car DVR 10 is disposed in the inner space of the car easily and conveniently. The design of the support 50 is based on space-saving and easy-assembling and is disposed on top of the car DVR 10, as shown in FIG. 7, or at the bottom of the car DVR 10, as shown in FIG. 8.

With regard to the structure, connection, function and related design of the integrated circuit of the time zone setting unit 30 and the microprocessor 40, they can be achieved and perfected by related electronic techniques available now so the details are not mentioned here.

Additional advantages and modifications will readily occur to those skilled in the art. Therefore, the invention in its broader aspects is not limited to the specific details and representative devices shown and described herein. Accordingly, various modifications may be made without departing from the spirit or scope of the general inventive concept as defined by the appended claims and their equivalents.

What is claimed is:

1. An automatic time adjusting device for global positioning systems (GPS) of car safety control systems comprising at least one car digital video recorder (DVR), a GPS receiver, a time zone setting unit and a microprocessor while the car safety control system comprising at least one car digital video recorder (DVR) and at least one GPS receiver; wherein
the car DVR disposed with a plurality of data storage units is used to record dynamic image and/or voice data in digital manner and save recorded real-time image and/or voice data into the data storage unit;
the GPS receiver that includes a receiving unit, a receiving end and an output end, receives location information of vehicles, clock signals of Greenwich Mean Time (GMT) and standard second signal from GPS satellite signal by the receiving unit and the receiving end and sends the information to the microprocessor by the output end;
the time zone setting unit is used to set values of time difference between GMT time and each of 24 time zones on earth by vehicle positioning information from GPS and is connected with the microprocessor;
the microprocessor is connected with the output end of the GPS receiver as well as the time zone setting unit and is for processing values of time difference provided by the time zone setting unit so as to determine current time data and send the current time data to the car DVR;
in accordance with the DVR, the GPS receiver, the time zone setting unit and the microprocessor connected with one another, the current time data is recorded in digital image data of the car DVR synchronously.

2. The device as claimed in claim 1, wherein the GPS receiver is operated in reference location relative to global WGS-84 coordinate system with C/A code.

3. The device as claimed in claim 1, wherein the location information of vehicles is recorded and displayed in digital image data of the car DVR synchronously as the current time data.

4. The device as claimed in claim 1, wherein the GPS automatic time adjusting device of car safety control systems further comprising a display unit disposed in the car DVR for showing the current time data.
